(19) United States
(12) Patent Application Publication
(10) Pub. No.: US 2007/0083895 A1
(43) Pub. Date: Apr. 12, 2007

(54) System and method of managing television information

(75) Inventors: Mary McCarthy, San Antonio, TX (US); Tony Haeuser, Aurora, IL (US); Chris Lee, San Antonio, TX (US); Ross Cox, Cumming, GA (US); Scott Pettit, San Antonio, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/248,593

(22) Filed: Oct. 12, 2005

(51) Int. Cl. H04N 7/173; G06F 3/00; G06F 13/00; H04N 5/445

(52) U.S. Cl. 725/46; 725/110; 725/112; 725/113

(57) ABSTRACT

The present disclosure is directed to a system and method to manage television information. The method includes receiving at least one user television viewing preference via an Internet site of a public network. The method also includes associating a user account with a set-top box device. The method also includes transmitting the at least one user television viewing preference to the set-top box device via a private network supporting an Internet Protocol Television (IPTV) system.

### FIELD OF THE DISCLOSURE

The present disclosure relates generally to managing television information.

### BACKGROUND

Television viewing is a popular form of entertainment. Developments in television and video technologies allow viewers to watch a wide variety of high-resolution content and to record programs to watch at a convenient time. Recent advancements, such as video-on-demand and the expansion of available channels, add to the breadth and convenience of television programming. Viewers have considerable freedom to determine and schedule the types of programming content to watch.

With all the choices that television audiences face, few viewers are likely to enjoy everything. Thus, managing television information is an important aspect of television viewing. Because service providers offer television channels in packages, many users configure their televisions to display certain channels. Viewers may simply be disinterested in some channels, or they may consider channels inappropriate for display to children. Addressing these management issues, as well as recording certain programs, can be inconvenient, because they require proximity to television monitors or other localized equipment.

### BRIEF DESCRIPTION OF THE DRAWINGS

FIG. 1 is a block diagram illustrating an embodiment of an Internet protocol television (IPTV) system;

FIG. 2 is an example embodiment of a user interface to manage television information within an IPTV system;

FIG. 3 is a flow diagram illustrating an embodiment of a method of managing television information within an IPTV system;

FIG. 4 is a screen shot diagram that illustrates a second embodiment of a method of managing television information within an IPTV system;

FIG. 5 is a general diagram that illustrates a particular embodiment of a user interface to manage television information via a wireless device; and

FIG. 6 is a diagram of a particular embodiment of a general computer system.

### DETAILED DESCRIPTION OF THE DRAWINGS

A system to deliver video games is disclosed and includes a set-top box (STB) device having a STB processor and a STB memory accessible to the processor. The system also includes a STB computer program embedded in the STB memory and executable by the STB processor. The computer program includes instructions to receive at least one user television viewing preference from a server via a private network. The computer program also includes instructions to execute the at least one user television viewing preference. The at least one user television viewing preference is received at the server via an Internet site of a public network.

In another embodiment, a method of managing television information is disclosed and includes receiving at least one user television viewing preference via an Internet site of a public network. The method also includes associating a user account with a set-top box device. The method also includes transmitting the at least one user television viewing preference to the set-top box device via a private network supporting an Internet Protocol Television (IPTV).

In another embodiment, a second method of managing television information is disclosed and includes receiving at least one user television viewing preference from a server within an Internet Protocol Television (IPTV) system, at a set-top box device via a private network supporting an IPTV platform. The method also includes implementing the at least one user television viewing preference in a display. The at least one user television viewing preference is received at the server via an Internet site of a public network.

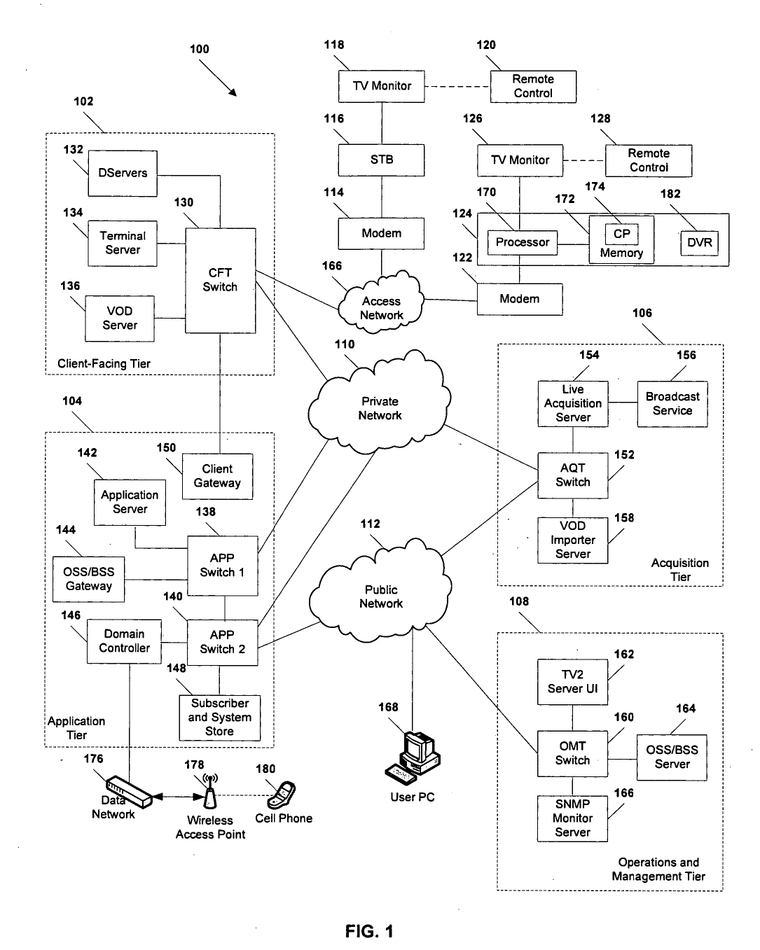

Referring to FIG. 1, an IPTV system is shown and is generally designated 100. As shown, the system 100 can include a client facing tier 102, an application tier 104, an acquisition tier 106, and an operations and management tier 108. Each tier 102, 104, 106, 108 is coupled to a private network 110, a public network 112, or both the private network 110 and the public network 112. For example, the client-facing tier 102 can be coupled to the private network 110. Further, the application tier 104 can be coupled to the private network 110 and to the public network 112, such as the Internet. The acquisition tier 106 can also be coupled to the private network 110 and to the public network 112. Moreover, the operations and management tier 108 can be coupled to the public network 112.

As shown in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

As illustrated in FIG. 1, the client-facing tier 102 can communicate with user equipment via a private access network 166, such as an Internet Protocol Television (IPTV) network. In an illustrative embodiment, modems, such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, or any other suitable geographic area that can be supported by networking the client-facing tier 102 to numerous set-top box devices.

In one embodiment, the client-facing tier 102 can be coupled to the modems 114, 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the private access network 166, via an IPTV software platform, such as Microsoft® TV IPTV Edition.

Additionally, the first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128.

In an exemplary, non-limiting embodiment, each set-top box device 116, 124 can receive data or video from the client-facing tier 102 via the private access network 166 and render or display the data or video at the display device 118, 126 to which it is coupled. In an illustrative embodiment, the set-top box devices 116, 124 can include tuners, such as the tuner 184 shown in FIG. 1, that receive and decode television programming information for transmission to the display devices 118, 126. Further, the set-top box devices 116, 124 can include a STB processor 178 and a STB memory device 180 that is accessible to the STB processor 178. In a particular embodiment, the set-top box devices 116, 124 can also communicate commands received from the remote control devices 120, 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server 168 and other devices with a common connection point to the private network 110. In a particular embodiment, the CFT switch 130 can also be coupled to a video-on-demand (VOD) server 136.

As shown in FIG. 1, the application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116, 124 via the private access network 166, so the set-top box devices 116, 124 can provide functions, such as display, messaging, processing of IPTV data and VOD material, etc. In a particular embodiment, the OSS/BSS gateway 144 includes operation systems and support (OSS) data, as well as billing systems and support (BSS) data.

Further, the second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116, 124 can access the system via the private access network 166, using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when a set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, e.g., because it is connected to a different twisted pair, the client gateway 150 can deny transmissions to and from the set-top box device 116 beyond the private access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 can transmit the television content to the AQT switch 152, in turn, and the AQT switch 152 can transmit the television content to the CFT switch 130 via the private network 110. Further, the television content can be encoded at the D-servers 132, and the CFT switch 130 can communicate the television content to the modems 114, 122 via the private access network 166. The set-top box devices 116, 124 can receive the television content from the modems 114, 122, decode the television content, and transmit the content to the display devices 118, 126 according to commands from the remote control devices 120, 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When a user issues a request for VOD content to a set-top box device 116, 124, the request can be transmitted over the private access network 166 to the VOD server 136, via the CFT switch 130. Upon receiving such a request, the VOD server 136 can retrieve requested VOD content and transmit the content to the set-top box device 116,124 across the private access network 166, via the CFT switch 130.

In an illustrative embodiment, the live acquisition server 154 can transmit the television content to the AQT switch 152, and the AQT switch 152, in turn, can transmit the television content to the OMT switch 160 via the public network 112. In this embodiment, the OMT switch 160 can transmit the television content to the TV2 server 162 for display to users accessing the user interface at the TV2 server 162. For example, a user can access the TV2 server 162 using the computer 176 coupled to the public network 112.

As shown in FIG. 1, the domain controller 146 communicates with the public network 112 via the second APP switch 140. Additionally, the domain controller 146 can communicate via the public network 112 with one or more user personal computers (PCs) 168. For example, the domain controller 146 can display a web portal via the public network 112 and allow users to access the web portal using a PC 168. Further, in an illustrative embodiment, the domain controller 146 can communicate with at least one wireless network access point 178 over a data network 176. In this embodiment, each wireless network access device 178 can communicate with user wireless devices, such as a cellular phone 180.

In a particular embodiment, a set-top box device, such as the second set-top box device 124, can include a STB processor 170 and a STB memory device 172 that is accessible to the STB processor 170. The set-top box device 124 also includes a STB computer program 174 that is embedded within the STB memory device 172. In a particular embodiment, the STB computer program 174 can contain instructions to receive and execute at least one user television viewing preference that a user has entered by accessing an Internet user account via the domain controller 146.

For example, the user can use the PC 168 to access a web portal maintained by the domain controller 146, via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124, by associating the user account with an IP address of the second set-top box device 124, with data relating to one or more twisted pairs connected with the second set-top box device 124, with data related to one or more fiber optic cables connected with the second set-top box device 124, with an alphanumeric identifier of the second set-top box device 124, with any other data that is suitable for associating second set-top box device 124 with a user account, or with any combination of these.

The STB computer program 174 can contain instructions to receive many types of user preferences from the domain controller 146 via the access network 166. For example, the STB computer program 174 can include instructions to receive a request to record at least one television program at a DVR 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device, such as the cellular phone 180. The message can be received at the CFT switch 130, for instance, and communicated to the domain controller 146 across the private network 110, via the second APP switch 140. Further, the domain controller 146 can transmit the message to the wireless data network 176, directly or via the public network 112, and on to the wireless network access point 178. The message can then be transmitted to the cellular phone 180. In an illustrative embodiment, the status can be sent via a wireless access protocol (WAP).

In another example, the STB computer program 174 can include instructions to receive from the domain controller 146 a sequence in which the user would like to view available channels. In this example embodiment, the STB computer program 174 includes instructions to transmit channels to the display device 128 in the sequence received. For instance, if the user prefers cable news networks to local networks, the user could input a sequence that places cable news networks on channels 2, 3, 4 or 5. Alternatively, the user could leave stations on their initial channels and alter the sequence in which the channels appear when channel up/down commands are received at the set-top box device 124.

In another example of possible user commands, the STB computer program 174 can include instructions to receive from the domain controller 146 a designation of at least one television program that the user wants to block. In this example, the STB computer program 174 can include instructions not to transmit the designated television program(s) to the display device 128, unless a portion of authentication information, such as a parental control code, is received at the set-top box device 124.

In a particular embodiment, the STB computer program 174 can also include instructions to receive from the domain controller 146 the portion of authentication information via the access network 166. In this embodiment, the user can enter the authentication information using the PC 168. The domain controller 146 can receive the authentication information and transmit it to the second APP switch 140, which transmits the authentication information to the CFT switch 130 over the private network 110. Further, the CFT switch 130 transmits the authentication information to the second set-top box device over the access network 166. Thus, designated television program(s) can be released without authentication information being entered directly at the set-top box device 124. In an illustrative embodiment, the portion of authentication information can be received at the domain controller 146 from the cellular phone 180 via a wireless access protocol.

In another example, the STB computer program 174 can include instructions to display a program guide at the display device 128 and to allow a user to determine which channels have information displayed in the program guide. In this embodiment, the STB computer program 174 can include instructions to receive from the domain controller 146 one or more favorite channels from the user. Further, the STB computer program 174 can include instructions to include only the favorite channel(s) in the television program guide.

In another example of viewing preferences, the STB computer program 174 can include instructions to receive from the domain controller 146 at least one available television channel that the user wants displayed and at least one available channel that the user does not want displayed. In this example, the STB computer program 174 can include instructions to transmit the channel(s) that the user wants displayed to the display device 128 and to not transmit the channel(s) that the user does not want displayed.

In an illustrative embodiment, data including preferences received at the Internet portal can be transmitted to a user's set-top box device 116, 124 via the private access network 110 within the IPTV system 100. For example, the user's preference data can be received at the domain controller 146 from the user's PC 168 via the public network 112. Further, the domain controller 146 can transmit the preference data to the client-facing tier 102 via the private network 110 within the IPTV system 100. The client-facing tier 102 can transmit the preference data to the user's set-top box device 116, 124 via the private access network 166.

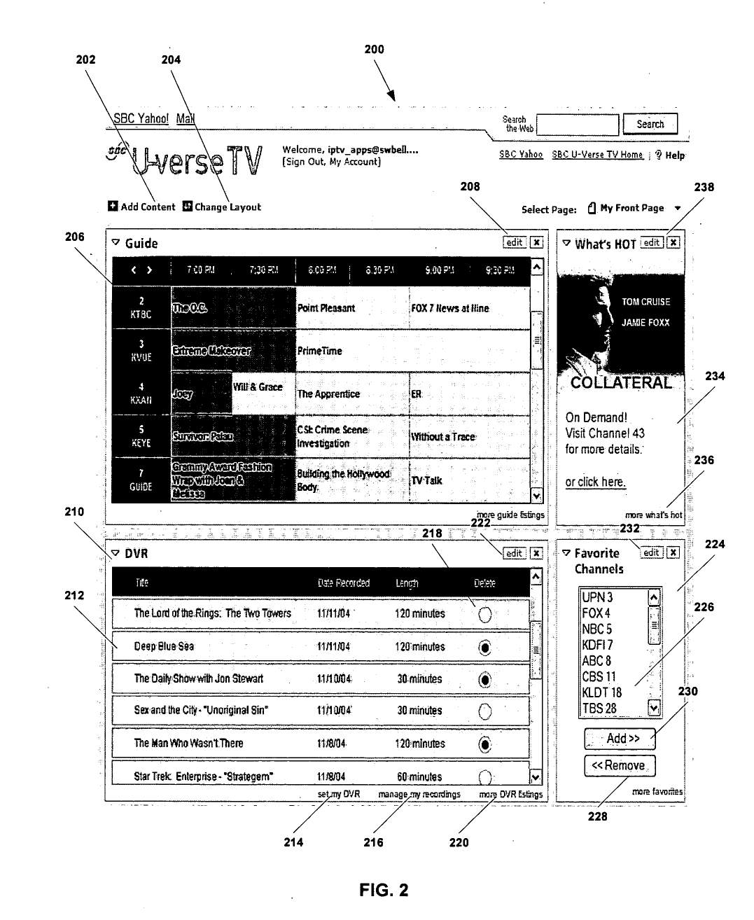

Referring to FIG. 2, a user interface for managing television information at an Internet portal is shown at 200. As shown, the user interface 200 can contain multiple sections that each correspond to various television information. In a particular embodiment, a user can change the contents of the user interface 200 by selecting a hyperlink or soft button 202. In this embodiment, the user can change the layout of the user interface 200 by selecting a hyperlink or soft button 204.

In a particular embodiment, the user interface 200 can include a program guide section 206. In this embodiment, the program guide section can include information regarding television programming on one or more channels. In an illustrative embodiment, the program guide can appear substantially similar to that displayed via a set-top box device at a television monitor or other display device. In a particular embodiment, the user can alter or close the program guide by selecting a link or soft button 208. Changes to the program guide can include which channels are shown on the program guide, the order in which channels are displayed, which times or days are displayed, or other information suited for informing a user of television programming on one or more channels.

In a particular embodiment, the user interface 200 can include a digital video recorder (DVR) management section 210. The DVR management section 210 can display a menu 212 of programs that have been recorded and are scheduled to be recorded by a DVR at the user's set-top box device. The DVR management section 210 can also include a link or soft button 214 to schedule a program to be recorded. The DVR management section 210 can also include a link or soft button 216 to manage recorded programs. Management functions can include, for example, altering a playback order of recorded programs, setting a time period after which a recorded program will be deleted from the DVR, arranging recordings into categories or genres, and other functions for managing a group of recordings. In an illustrative embodiment, managing recordings can also include deleting individual programs. In another illustrative embodiment, individual programs can be deleted via the menu 212 that displays the programs, as shown at 218.

In an illustrative embodiment, the DVR management section 210 can display recordings and scheduled recordings for a certain number of most recent days. In this embodiment, the user can select a link or soft button 220 to view additional recordings that precede the number of days shown in the menu 212. In a particular embodiment, the DVR management section 210 can include a link or soft button 222 that the user can select to edit or close the display of the DVR management section 210, as shown.

In a particular embodiment, the user interface 200 can include a favorite channels section 224. The favorite channels section 224 can display a listing 226 of favorite channels that have been identified by the user. In an illustrative embodiment, the user can add or erase channels on the favorites list 226 using soft buttons, such as those shown at 228 and 230. In a particular embodiment, the user can select a link or soft button 232 to edit or close the display of favorite channels.

In a particular embodiment, the user interface 200 can include a features section 234, such as a “What's Hot” section. The features section 234 can include, for example, information on current or upcoming programming that might interest the user. The features section 234 can include a link or soft button 236 that the user can select to see more features. For example, features could be listed for multiple channels, depending on user preferences. In a particular embodiment, a link or soft button 238 can be selected by the user to edit or close the features section 234.

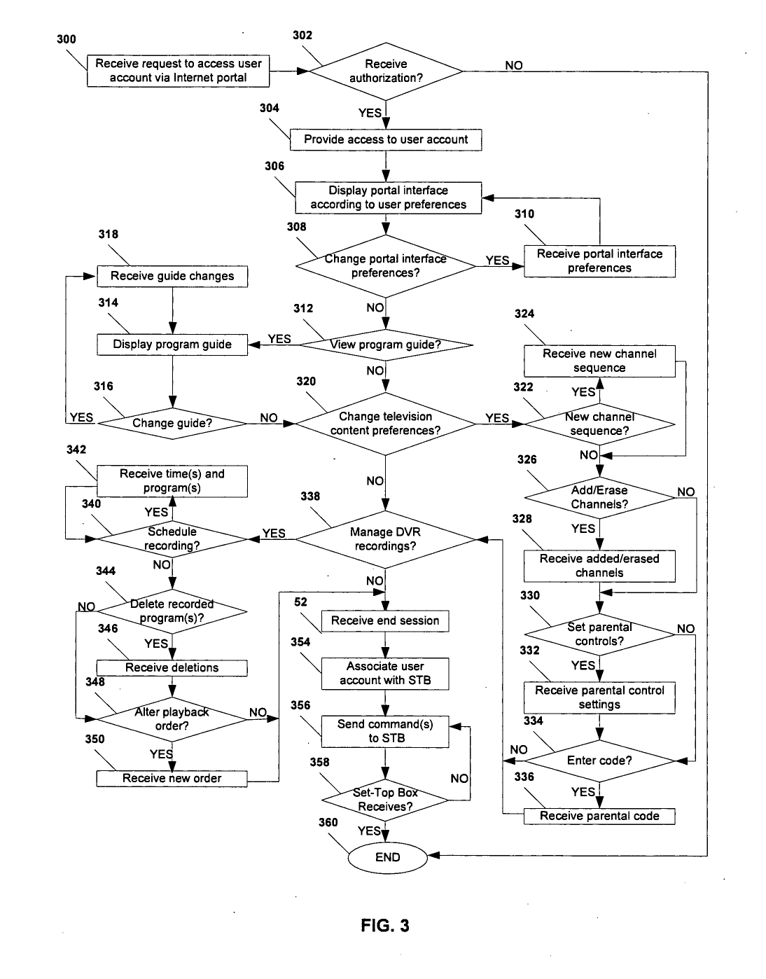

Referring to FIG. 3, a method of managing television information is shown. At block 300, a request to access a user account is received via an Internet portal. In a particular embodiment, the request can be received at a server of a computer network. In an illustrative embodiment, the request can be received via the Internet from a personal computer or a wireless device, such as a laptop computer or a cellular phone. At decision step 302, it is determined whether authorization information that corresponds to the account has been received. For example, it can be determined whether a user identification and password is received. If the correct authorization information is not received, the method terminates at 360. If the correct authorization information is received, the method proceeds to block 304, and access to the user account is provided.

In a particular embodiment, as shown at block 306, the Internet portal can be displayed according to preferences established by the user. These preferences can include, for example, the display of certain features, such as a program guide, digital video recorder (DVR) information, favorite channels, upcoming programming events, and the like. In this embodiment, a selection to change the display preferences for the Internet portal can be received via the portal at decision step 308. If such a selection is received, the method proceeds to block 310 and changes are received. In a particular embodiment, the Internet portal can be displayed according to the new preferences, by returning to block 306.

If no further selection to change portal display preferences is received, the user can change preferences relating to television viewing and programming at the Internet portal, and these preferences can be transmitted to and implemented at the user's set-top box device and a display device coupled thereto. In a particular embodiment, a selection to view a program guide can be received at decision step 312. The program guide displayed via the Internet portal can be substantially similar to a program guide displayed at a display device by the user's set-top box device. If a selection to display the program guide at the Internet portal is received, the program guide is displayed at block 314.

Additionally, a selection to change the program guide can be received at decision step 316. If such a selection is received, changes to the program guide can be received at block 318. In a particular embodiment, the program guide can be displayed with the changes at the Internet portal. Changes to the program guide can include changing which channels are and are not shown on the program guide; changing a sequence in which channels are shown on the program guide; and any other changes that are suited to meet the preferences of a user for viewing channel and program information using a program guide. In an illustrative embodiment, one or more favorite channels can be received from the user and only the favorite channels can be displayed to the user in the program guide at the Internet portal and via the user's set-top box device.

In another example of preferences that a user can define using the Internet portal, it can be determined, at decision step 320, whether a selection to change television content preferences has been received. If a selection to change television content preferences is received, the method proceeds to decision step 322 and it is determined whether a selection to change a sequence in which channels are displayed via a set-top box at a television monitor or other display device. If a selection to change the channel sequence is received, a new sequence can be received at block 324. In an illustrative embodiment, a new channel sequence can include an original sequence created by the user or changes to a current sequence.

Moving to decision step 326, in another example of preferences that the user can define at the Internet portal, it can be determined whether a selection to add or erase available channels to be displayed at a television monitor or other display device via a set-top box has been received. In this embodiment, if a selection to add or erase channels is received, one or more channels that are to be displayed and one or more channels that are not to be displayed can be received at block 328.

At decision step 330, in yet another example of preferences that the user can define at the Internet portal, a selection to set parental controls can be received. For example, a user can use parental controls to block channels or individual television programs, unless an authorization or code is received at a set-top box device. If a selection to set parental controls is received, parental controls can be received at block 332. In an illustrative embodiment, the parental controls that are received can be channels and/or television programs that are to be blocked, as well as an authorization or code for each program or channel or for all programs and channels. In a particular embodiment, information regarding the channels and/or programs that are to be blocked can also be blocked for the program guide, unless the authorization or code is received at the set-top box device.

In a particular embodiment, it can be determined at decision step 334 whether a selection to entering an authorization or code is received. In this embodiment, the authorization or code can be received at block 336. Thus, a user can release one or more channels or programs that are blocked with parental controls, by entering a required authorization or code via the Internet portal, rather than directly at the set-top box device. In an illustrative embodiment, the authorization or code can be entered via the Internet portal using a personal computer or a wireless device, such as a laptop device or cellular phone.

Moving to decision step 338, in a particular embodiment, it can be determined whether a selection to manage digital video recorder (DVR) recordings is received. In this embodiment, if a selection to manage DVR recordings is received, it can be determined whether a selection to schedule one or more recordings is received, at decision step 340. If a selection to schedule one or more recordings is received, the programs and times can be received at block 342. In an illustrative embodiment, the method can return to decision step 340 and it can be determined whether any additional recordings are to be scheduled.

At decision step 344, in a particular embodiment, it can be determined whether a selection to delete any recorded programs is received. In this embodiment, if a selection to delete recorded programs is received, the programs to be deleted can be received at block 346, and the programs can be deleted at the DVR. In a particular embodiment, at decision step 348, it can be determined whether a selection to alter the order of playback for any recorded programs is received. If a selection to alter the playback order for programs recorded at the DVR is received, changes to the order can be received at block 350.

In an illustrative embodiment, a command to end access to the user account can be received at block 352. In this embodiment, a log out command can be received, for example, a session end command can be received; or any other command suited to mark the end of a session to make changes to the user account can be received.

In a particular embodiment, the user account at which the user commands are being received can be associated with a set-top box device at block 354. In this embodiment, an information store that relates various set-top box devices to corresponding user accounts can be queried. For instance, in an illustrative embodiment, the information store can relate a user account to a particular set-top box device by associating a user account with: an IP address of the set-top box device; with one or more twisted pairs connected with the set-top box device; with data related to one or more fiber optic cables connected with the set-top box device; with an alphanumeric identifier of the set-top box device; with any other data that is suitable for associating a set-top box device with a user account; or with any combination of these.

In a particular embodiment, at block 356, the user commands received from the user via the Internet portal can be transmitted to the set-top box device associated with the user's account. These commands can include changes to the program guide; changes to the television channel sequence; add/erase commands, DVR requests, deletions and playback changes; parental control settings and authorization codes for releasing channels or programs. In one embodiment, changes are transmitted after a session end, although changes can be transmitted to the set-top box device as they are received from the Internet portal.

In an illustrative embodiment, data including preferences received at the Internet portal can be transmitted to a user's set-top box device via a private access network within an IPTV system, such as that shown in FIG. 1. For example, the user's preference data can be received at the domain controller 146 from the user's PC 168 via the public network 112. Further, the domain controller 146 can transmit the preference data to a client-facing tier 102 via a private network 110 within the IPTV system 100. The client-facing tier 102 can transmit the preference data to the user's set-top box device 116, 124 via the private access network 166.

In an illustrative embodiment, it can be determined at decision step 358 whether transmitted commands are received at the set-top box device. If they are not, the method can return to block 356, and the commands can be transmitted again. If they ware received, the method terminates at 360.

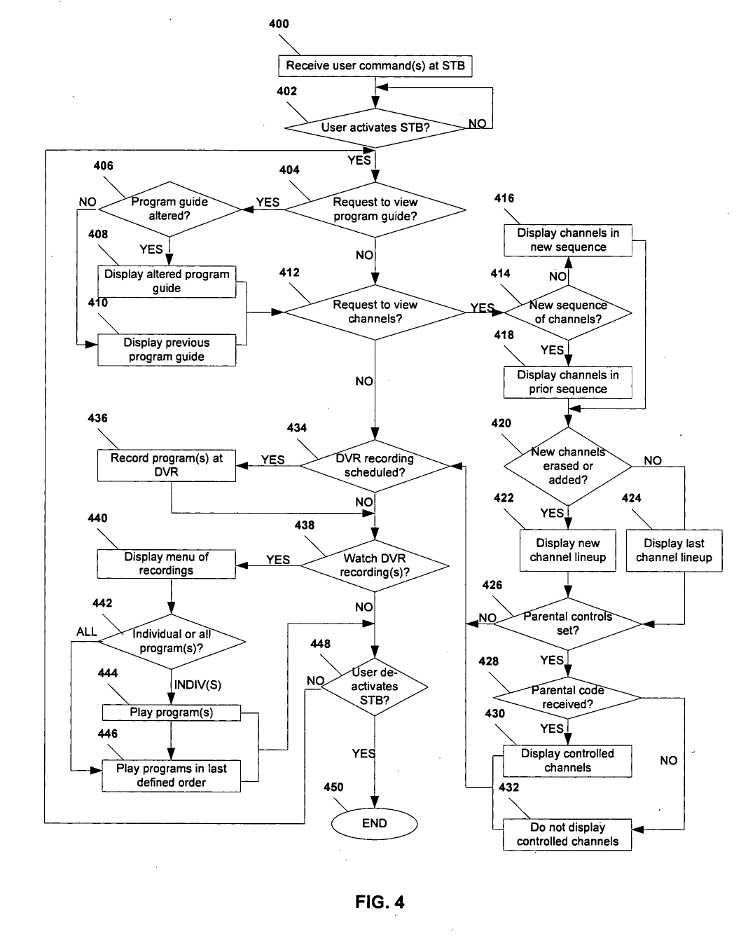

Referring to FIG. 4, a second embodiment of a method of managing television information is shown. At block 400, one or more user commands are received at a set-top box device. In a particular embodiment, the user command(s) affect content displayed via the set-top box device at a television monitor or other display device. In an illustrative embodiment, the user command(s) can be received from a server that has received the commands from a user via an Internet portal.

In a particular embodiment, at decision step 402, it can be determined whether the set-top box device has been activated by a user, such that television content and programming information can be displayed at a television monitor or other display device. For example, activation can include powering the set-top box device on or changing its mode from a standby mode to an active mode.

In a particular embodiment, at block 404, a selection to display a program guide can be received at the set-top box device. For example, a user can issue a command directly at the set-top box device, or from a remote control device to the set-top box device, to display the program guide at a television monitor. In this embodiment, if a selection to display the program guide is received at the set-top box device, the program guide that is displayed can be determined, at decision step 406, by whether any user commands to change the program guide have been received at the set-top box device since the last time it was displayed. If changes have been made and received from the server, for instance, the altered program guide can be displayed at block 408. If no user commands to change the program guide have been received, then the same program guide that was last displayed is displayed at block 410.

Moving to decision step 412, a selection to view available channels can be received at the set-top box device. For example, a user can use a remote control that communicates with the set-top box device to scroll through channels or change from the program guide to television programming. In this embodiment, television content on selected channels can be displayed via the set-top box device at a television monitor. In a particular embodiment, if a selection to view available channels is received at the set-top box device, channels can be shown in a sequence that is determined, at decision step 414, by whether user commands to change the channel sequence have been received by the set-top box device. In this embodiment, if user commands to change the channel sequence have been received at the set-top box device since the last time channels were viewed, the set-top box device can display channels in the new sequence, as a user changes channels, at block 416. If no user commands to change the sequence have been received since the last time channels were viewed, then the channels can be displayed in the sequence last viewed at block 418.

In a particular embodiment, the channels that are displayed by the set-top box device in response to a selection to view available channels can also be determined, at decision step 420, by whether any user commands to add or erase channels have been received since the last time channels were viewed. In this embodiment, if user commands to add or erase channels have been received at the set-top box device since the last time channels were viewed, the new channel lineup can be displayed as a user changes channels, at block 422. If no user commands to add or erase channels have been received at the set-top box device since the last time channels were viewed, the most recent channel lineup can be displayed as a user changes channels, at block 424.

Moving to decision step 426, in a particular embodiment, it can be determined whether user commands to use parental controls to block one or more channels or programs from display have been received at the set-top box device. In this embodiment, if parental controls have been set, it can be determined at decision step 428 whether corresponding authorizations or codes for any blocked channels or programs have been received. If the authorization(s) or code(s) have been received, the corresponding channel(s) or program(s) are displayed via the set-top box device at block 430. If the authorization(s) or code(s) have not been received, the corresponding channel(s) or program(s) are not displayed via the set-top box device at block 432. In a particular embodiment, information regarding the channel(s) or program(s) is not displayed on a program guide displayed by the set-top box device, unless the authorization(s) or code(s) are received. In an illustrative embodiment, the authorization(s) or code(s) can be received at the set-top box, whether directly or via a remote control. In another embodiment, the authorization(s) or code(s) can be received at the set-top box from a server that has received them from a user via an Internet portal.

In a particular embodiment, it can be determined at decision step 434 whether a DVR recording has been scheduled. In this embodiment, a user command to schedule a DVR recording can be received at the set-top box device, whether directly or from a server that has received the scheduling information from a user via an Internet portal. Scheduled programs are thus recorded at their scheduled times, at block 436.

Moving to decision step 438, in a particular embodiment, a selection to watch DVR recordings can be received at the set-top box device. In this embodiment, if a selection to watch DVR recordings is received at the set-top box device, from a remote control, for example, a menu of recorded programs can be displayed at block 440. It can be determined at decision step 442 whether a selection has been received from the user to play back one or more individual programs, or all recorded programs. If one or more individual programs are to be played, the set-top box can display the program(s) for playback at the television monitor or other display device at block 444. In a particular embodiment, if all recorded programs are to be displayed, the programs can be displayed at block 446 in the order most recently defined by the user via the Internet portal.

Moving to block 448, in a particular embodiment, a selection can be received from the user to de-activate the set-top box device. For example, the user can issue a command to the set-top box device from a remote control to place the set-top box device in a standby mode. In this embodiment, so long as no selection to de-activate the set-top box is received, the method can return to any of the functions disclosed, as shown in FIG. 4. If the set-top box device is de-activated at decision step 448, the method terminates at 450.

In a particular embodiment, the steps of the methods described herein are executed in the order shown by the figures. In alternative embodiments, the steps may be executed in alternative sequences. For example, commands received at a server via an Internet portal can be transmitted to the set-top box device at a number of times. In an illustrative embodiment, user commands can be transmitted to a set- top box device, as they are received from the user. In another illustrative embodiment, user commands can be transmitted to a set-top box device when a user's session at the Internet portal ends. In another illustrative embodiment, user commands can be transmitted to a set-top box device when the set-top box device is activated or powered on.

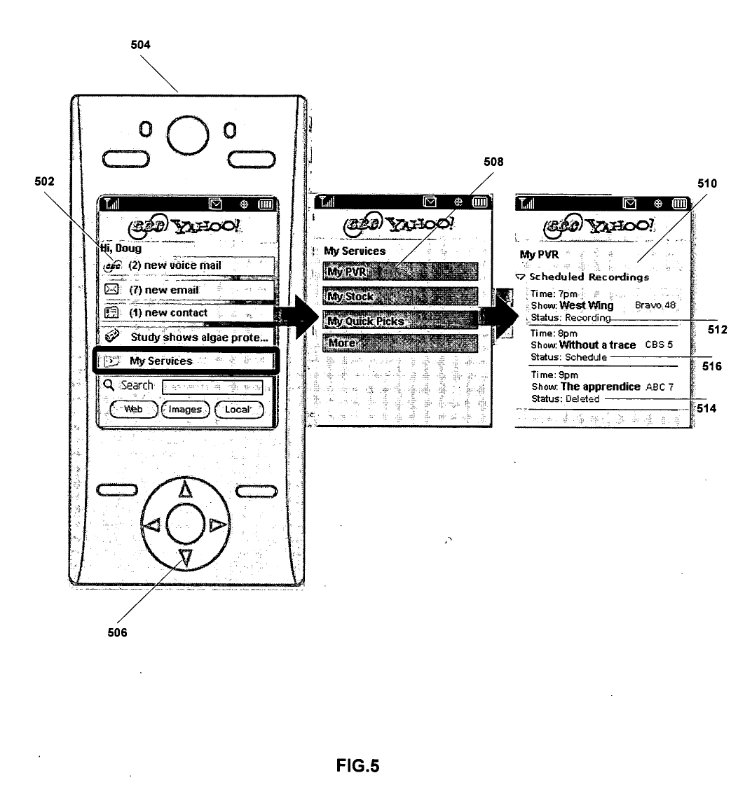

Referring to FIG. 5, an example embodiment of a user interface to manage television information is shown. In a particular embodiment, a user interface 502 can be communicated to a wireless device 504, such as a cell phone, handheld computing device, laptop or other suitable wireless device. In this embodiment, a user can use keys or buttons 506 on the wireless device 504 to navigate through the user interface 502 and select television information to view. For example, the user can navigate through the user interface 502 and select a menu of programs 510 that can be recorded by a digital video recorder at the user's set-top box device. In this example, the menu of programs can include status indicators, such as whether a program is being recorded, as shown at 512, or deleted from recording, as shown at 514. Further, the menu 510 can include commands, such as whether the user wishes to schedule a program for recording, as shown at 516.

In conjunction with the configuration of structure described herein, the system and method disclosed provides remote web access to manage television information at a set-top box device. The association of set-top box devices with user accounts via an Internet portal allows users to manage television programming and information without requiring proximity to a set-top box device or television monitor. Moreover, communicating with the Internet portal via wireless devices, such as cellular phones, can allow users to manage television programming and information while mobile and away from a computing device.

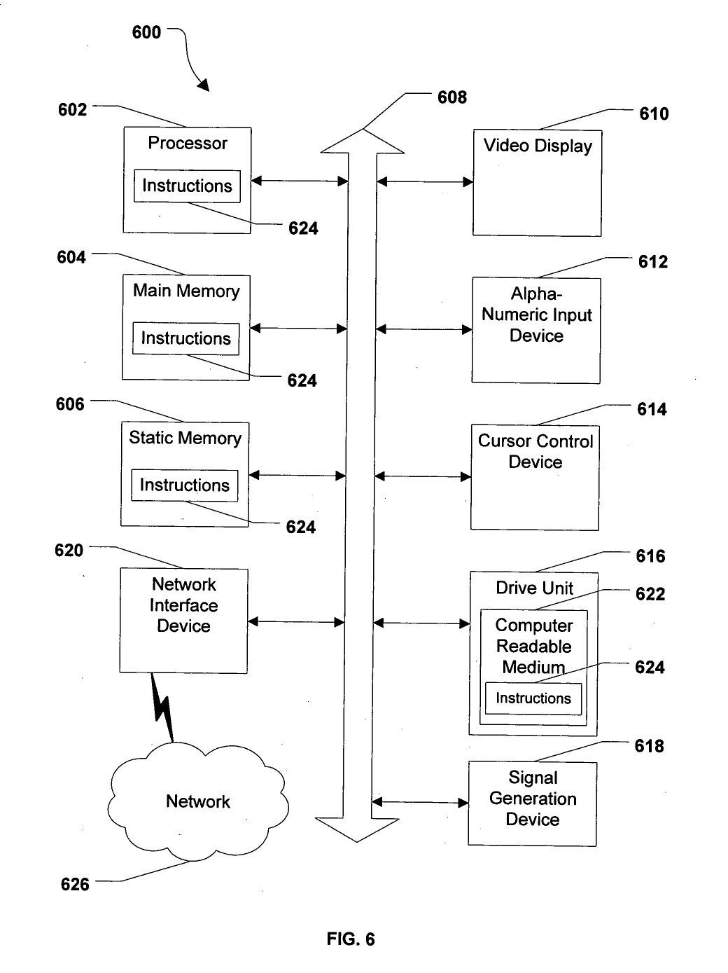

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. Further, the computer system 600 can include a wireless input device 615, e.g., a remote control device. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of managing television information, the method comprising:
receiving at least one user television viewing preference associated with a user account via an Internet site of a public network;
associating the user account with a set-top box device; and
transmitting the at least one user television viewing preference to the set-top box device via a private network supporting an Internet Protocol Television (IPTV) system.

2. The method of claim 1, further comprising:
receiving, via the Internet site, a request to record at least one television program at a digital video recorder (DVR) within the set-top box device; and
transmitting the request to the DVR.

3. The method of claim 2, further comprising:
receiving a recording status of a DVR recording from the set-top box device via the private network; and
sending at least one message regarding the recording status to a wireless device via a wireless network.

4. The method of claim 3, wherein the at least one message is sent via a wireless access protocol (WAP).

5. The method of claim 1, wherein the at least one television viewing preference includes a designated television program and wherein the method further comprises:
receiving a portion of authentication information associated with the designated television program via the Internet user account; and
transmitting the portion of authentication information to the set-top box device.

6. The method of claim 1, wherein the at least one television viewing preference includes a designated television channel and wherein the method further comprises:
receiving a portion of authentication information associated with the designated television channel via the Internet user account; and
transmitting the portion of authentication information to the set-top box device.

7. The method of claim 6, further comprising including programming information regarding the designated television channel in a television program guide transmitted to the set-top box device.

8. The method of claim 1, wherein the at least one television viewing preference includes at least one favorite channel and wherein the method further comprises:
transmitting a television program guide including the at least one favorite channel to the set-top box device.

9. The method of claim 8, further comprising transmitting the television program guide to a web browser via the Internet site.

10. A method of managing television information, the method comprising:
receiving at least one user television viewing preference from a server within an Internet Protocol Television (IPTV) system, at a set-top box device via a private network supporting an IPTV platform;
implementing the at least one user television viewing preference in a display; and
wherein the at least one user television viewing preference is received at the server via an Internet site of a public network.

11. The method of claim 10, further comprising transmitting the display to a display device.

12. The method of claim 10, wherein the user account is associated with the set-top box device at an information store coupled to the server.

13. The method of claim 10, further comprising:
receiving a request via a private network to record at least one television program at a digital video recorder (DVR) within the set-top box device;
recording the at least one television program at the DVR; and
wherein the user sends the request to the Internet site of the public network.

14. The method of claim 13, further comprising:
generating a message regarding a status of the DVR;
transmitting the message to the server via the private network; and
wherein the message is transmitted from the server to a wireless device via a wireless network.

15. The method of claim 10, wherein the at least one television viewing preference includes a sequence of a plurality of channels and wherein the method further comprises:
transmitting the plurality of channels to the display device in the sequence.

16. A system to receive television information, the method comprising:
a set-top box device comprising a processor and a memory accessible to the processor; and
a computer program embedded in the memory and executable by the processor, the computer program comprising
instructions to receive at least one user television viewing preference from a server via a private network;
instructions to execute the at least one user television viewing preference; and
wherein the at least one user television viewing preference is received at the server via an Internet site of a public network.
